(19) United States
(12) Patent Application Publication
(10) Pub. No.: US 2008/0026725 A1
(43) Pub. Date: Jan. 31, 2008

(54) Gateway device for remote control and method for the same

(75) Inventor: Soon-back Cha, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/654,657

(22) Filed: Jan. 18, 2007

(30) Foreign Application Priority Data
Jul. 31, 2006 (KR) 10-2006-0072313

(51) Int. Cl. H04M 1/66

(52) U.S. Cl. 455/411

(57) ABSTRACT

A gateway device for remote control and a method for the same are provided. The gateway device includes a verifying unit which verifies whether a user has a proper authority to access the gateway connected to a device; a guide unit which provides information about the device to the communication terminal of the user if it is verified that the user has the proper access authority; a generating unit which generates a control command corresponding to information selected by the user among the information provided to communication terminal; a converting unit which converts the control command which is generated to be compatible with a protocol used by the device; and a transceiver which transmits the control command to the device.

### CROSS-REFERENCE TO RELATED APPLICATION

This application is based on and claims priority from Korean Patent Application No. 10-2006-0072313, filed on Jul. 31, 2006 in the Korean Intellectual Property Office, the disclosure of which is incorporated herein in its entirety by reference.

### BACKGROUND OF THE INVENTION

1. Field of the Invention

Apparatuses and methods consistent with the present invention relate to a gateway device for remote control, and more particularly, to connecting a communication terminal of a remote user and a gateway device that is connected in a wired or wireless manner to the devices in a home network, transmitting a predetermined control command, and thereby allowing the user to remotely control the devices.

2. Description of the Related Art

An Internet appliance is a next-generation device, in which information devices, such as audio and video (A/V) devices, personal computers (PCs), and home devices, such as refrigerators and washing machines, are networked in a wired or wireless manner, thereby performing data communication with one another. An Internet Protocol (IP) address is allotted to each Internet appliance, which makes an Internet connection possible. In addition, voice recognition and speech synthesis technologies are used, which enable security management using individual biometrics and voice-initiated operation. The purpose of the Internet appliance is to enable home devices to connect with one another. In order for home devices to be connected to the Internet and perform data communication with other devices, a high speed communication network, such as an asymmetric digital subscriber line (ADSL), should be connected to a home, and home appliances must be networked in a wired or wireless manner. A home network connects digital information devices to the high speed Internet in order to provide data reception and transmission, multimedia information exchange, and control commands of various devices. A home networks can be classified as a wired network that uses telephone wires or power cables, or a wireless network, such as Bluetooth or a home radio frequency (RF) network.

Internet telephone over the home network transmits data packets through the Internet, and transmits and receives voice and images. The user can receive the communication service by accessing the Internet using local area network (LAN) cables instead of conventional telephone cables anywhere the Internet is available, and the installation is convenient. Further, the user can set the call reject or call switch through the Internet, and can be linked to company software applications, including Outlook.

However, the functions of the Internet telephone and remote-control home appliances must be improved.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides remote control of home appliances through a method of connecting communication terminals of a remote user and a gateway device connected in a wired or wireless manner to the devices on home network, and transmitting a predetermined control command.

According to an aspect of the present invention, there is provided a gateway device for remote control, the gateway device including a verifying unit which verifies whether a user has a proper authority to access to the gateway connected to home devices, a guide unit which provides information about the home device to the user's communication terminal if the user has the proper authority to access, a generating unit which generates a control command corresponding to information selected by the user among the information provided to communication terminal, a converting unit which converts the generated control command to be compatible with a protocol used by the home device, and a transceiver which transmits the control command to the home device.

According to another aspect of the present invention, there is provided a method for remote control, the method including verifying that a user has a proper authority to access a gateway, providing the user's communication terminal with information about the home device if the user has the proper access authority, generating a control command corresponding to information selected by a user among the information provided to the communication terminal, converting the generated control command to be compatible with a protocol used by the home device, and transmitting the control command to the home device.

### BRIEF DESCRIPTION OF THE DRAWINGS

The above and other aspects of the present invention will become apparent by describing in detail exemplary embodiments thereof with reference to the attached drawings, in which:

FIGS. 1a and 1b are conceptual diagrams illustrating remotely controlling a home appliance from a user's communication terminal according to an exemplary embodiment of the present invention;

FIG. 2 is a block diagram illustrating a gateway device for remote control according to an exemplary embodiment of the present invention;

FIG. 3 is a flowchart illustrating a method of remotely controlling a home appliance according to an exemplary embodiment by using the system of FIG. 2; and

FIGS. 4a and 4b illustrate how home appliances are remotely controlled by a user's communication terminal according to an exemplary embodiment of the present invention.

### DETAILED DESCRIPTION OF EXEMPLARY EMBODIMENTS OF THE INVENTION

Advantages and features of the aspects of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims and their legal equivalents. Like reference numerals refer to like elements throughout the specification.

Java intelligent network infra-structure (JINI) is a communication technology between Java objects, which is used after installing a Java program in an A/V device, PC, copier, or others connected to a home network.

Digital living network alliance (DLNA) is a digital home networking standard that allows media content, such as music, images, and video, to be shared freely through a home network.

Ultra-wide band (UWB) is a wireless data transmission technology using an ultra-wide band of a predetermined frequency (GHz).

Exemplary embodiments of the present invention will be described with reference to flowchart illustrations of methods.

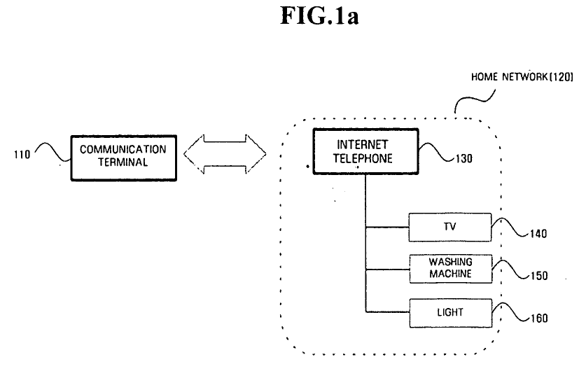

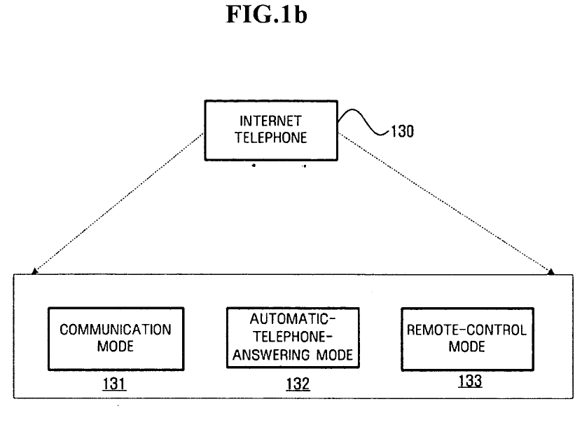

FIGS. 1a and 1b are conceptual diagrams illustrating remotely controlling a home appliance from a user's communication terminal according to an exemplary embodiment of the present invention.

As illustrated in FIG. 1a, after connecting to the Internet telephone 130 installed in a home network 120 by using a communication terminal 1 10 away from the home, a user can use the conventional communication service, or control home appliances, such as a television (TV) 140, washing machine 150, electric lights 160, or boiler, which are connected to the Internet telephone 130. To accomplish this, the apparatus of the present invention acts as a gateway for a remote control included in the Internet telephone 130. Examples of the communication terminal 110 include a mobile phone, a personal communication system (PCS), and a conventional telephone. Therefore, home appliances can be remotely controlled by using conventional communication devices. The communication terminal 110 and the Internet telephone 130 can communicate using the Internet, or via a gateway base station. The Internet telephone 130 on the home network 120 can be connected to home appliances in a wired or wireless manner, and the devices can be connected to the Internet telephone 130 by using their own protocol. For example, the protocol may be a home phone line networking appliance (PNA), IEEE 1394, Universal Serial Bus (USB), Ethernet, power line communication (PLC), Infrared Data Association (IrDA), Bluetooth, wireless LAN, home RF, UWB, DLNA, JINI, and universal plug and play (UPnP).

As illustrated in FIG. 1b, a remote-control mode function 133, including a communication mode 131 and automatic-telephone-answering mode 132, can be added to the Internet telephone 130. If a user connects to the Internet telephone 130 using the communication terminal 110 that fails, an automatic telephone answering message appears. In addition, the present invention provides a message asking if the user wants to convert a mode into the remote-control mode 133, as well as the communication function of the Internet telephone 130. If the user requests conversion to the remote-control mode 133 through his or her terminal, the apparatus of the present invention converts the Internet telephone 130 to the remote-control mode 131, and conducts a user authentication. If authenticated, the user can control home appliances with his or her communication terminal from a distance. The user can request conversion to the remote-control mode 133 through voice, image, or by clicking a key button on the communication terminal 110.

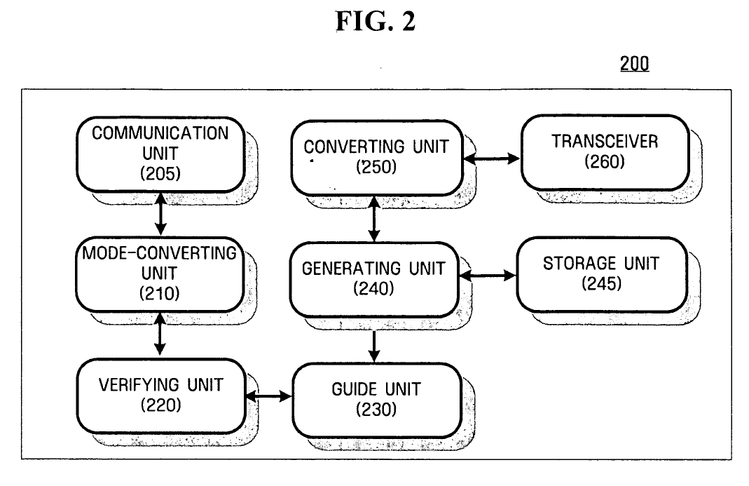

FIG. 2 is a block diagram illustrating a gateway device for remote control according to an exemplary embodiment of the present invention.

A gateway device 200 for remote control includes a communication unit 205, a mode-converting unit 210, a verifying unit 220, a guide unit 230, a generating unit 240, a storage unit 245, a converting unit 250, and a transceiver 260. As mentioned above, an Internet telephone has been exemplified as the gateway device 200 for remote control in the present invention. However, the present invention is not limited thereto. The communication unit 205 transmits and receives predetermined data from a communication terminal of a user. For example, the communication unit 205 can receive a predetermined connection signal when a user tries to connect the communication to the Internet telephone using a communication terminal. The communication unit 205 can receive the voice, image, and button signals from the user's communication terminal.

When a user tries to connect communication to the Internet telephone using his or her communication terminal, the mode-converting unit 210 converts the mode of the Internet telephone based on a predetermined condition. For example, the mode of the Internet telephone may include a communication mode, which is the function of a general telephone, an automatic-answering mode, and a remote-control mode. If a remote user tries to connect communication to the Internet telephone using a communication terminal but fails, a message requesting conversion to the remote-control mode for remotely controlling the device is transmitted to the communication terminal of the user through the communication unit 205. When a remote user receives the message and request for conversion to the remote-control mode through the communication unit 205, the mode-converting unit 210 converts the mode of the Internet telephone to the remote-control mode. At this time, the user can request the mode-converting unit 210 to convert a mode to the remote-control mode through voice or image, or by clicking a predetermined key button on a communication terminal.

The verifying unit 220 checks whether a user who requested for the conversion has a proper access authority. For example, the verifying unit 220 can conduct verification using personal information, a finger print, a voice, an image of the user's iris, another image, the user's digital signature, or a combination thereof.

When a user has a proper authority to access, the guide unit 230 provides information about the device to the user's communication terminal. The information about the device may include the name, control function, model number, and manufacturing company of the device. The guide unit 230 can provide information about the device to the user's communication terminal in a voice or image format. The user acquires the information about the device output from the communication terminal, and selects the function for controlling the device that he or she wants to control.

The generating unit 240 generates a control command corresponding to information selected by a user from the information provided to the communication terminal. At this time, the generating unit 240 searches for the content stored in the storage unit 245, and generates the control command. The user directly touches the voice, key button of a communication terminal, list of the device output on the liquid crystal display (LCD) screen of a communication terminal, and control functions of each device, on his or her communication terminal, or uses the movement button. At this time, the generation unit 240 generates a control command corresponding to the information selected by the user. The control command may be a data packet of predetermined bit rays composed of command languages corresponding to the original number of home appliances and the control function of each home appliance. The original number can be configured by using identification information of the device, such as a universally unique identifier (UUD) within an operating manual, or an IP address allotted to each device. The command can be allotted based on the control function of each device. For example, the value of “01” can be allotted when the light is to be on, and the value of “00” can be allotted when the light is to be off.

The storage unit 245 stores a predetermined command language corresponding to the original number, IP address, and control command of the device, and the information about the protocol that every home appliance uses. The storage unit 245 may store the information in a table format.

The conversion unit 250 converts the generated control command so that it is compatible with the protocol used by the home devices. At this time, the conversion unit 250 can convert the control command to be compatible with the protocol of the corresponding device, with reference to the information about the protocol of the device stored in the storage unit 245. For example, when the control command is composed of the command language and the original number of home appliances, the conversion unit 250 compares the original number in the storage unit 245 and that of the control command, and extracts the information about the protocol of the device having the same original number. Therefore, the conversion unit 250 can convert the control command according to the specification of each protocol. The protocol used by the device included in home network can be home PNA, IEEE 1394, USB, Ethernet, PLC, IrDA, Bluetooth, wireless LAN, home RF, UWB, DLNA, JINI, and AnyNet.

The transceiver 260 transmits the converted control command to the device selected by the user in his or her communication terminal. The transceiver 260 receives the result of the operation conducted by the device, and converts it into a voice format or an image format for the communication terminal of the user.

Each component illustrated in FIG. 2 can be composed of modules. The term “module”, as used herein, means, but is not limited to, a software or hardware component, such as a Field Programmable Gate Array (FPGA) or an Application Specific Integrated Circuit (ASIC), which performs certain tasks. A module may advantageously be configured to reside on the addressable storage medium and to execute on one or more processors. Thus, a “unit” may include components, such as software components, object-oriented software components, class components, and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules, or further separated into additional components and modules.

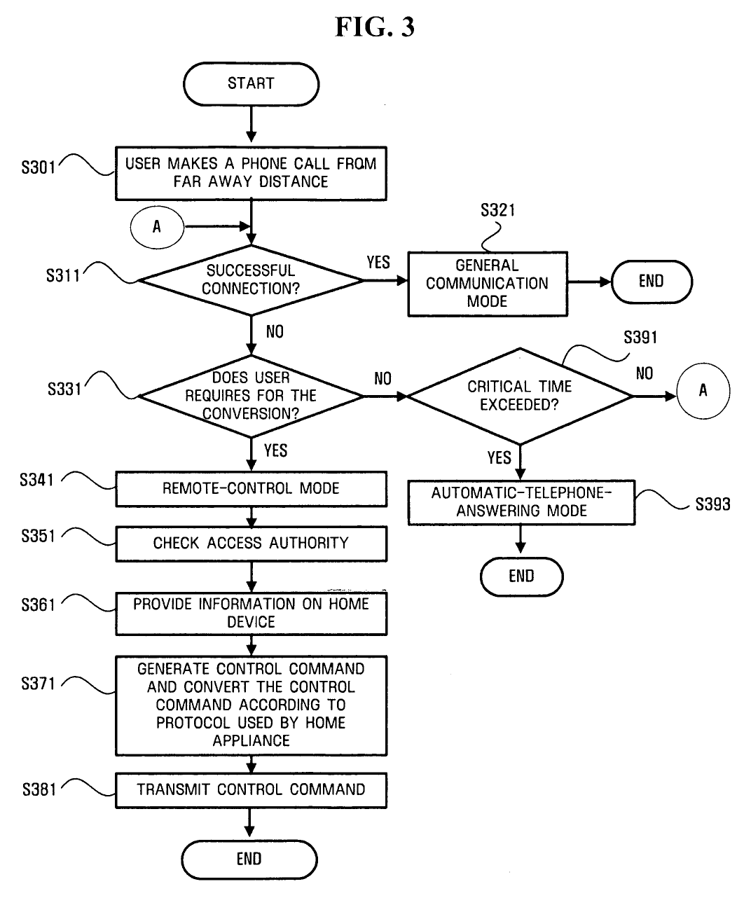

FIG. 3 is a flowchart illustrating a method of remotely controlling a home appliance according to an exemplary embodiment by using the system of FIG. 2.

Content described above with reference to FIG. 2 will be omitted, if possible, and the process of remote control will be described for each step.

The method of remotely controlling home appliance will be described for the situation in which the remote user makes a phone call to the Internet telephone connected to the devices on a home network by using his or her mobile phone.

When the communication is connected, the mode conversion unit 210 converts the Internet telephone into a general communication mode, so that the user can make a phone call normally (S301, S311, and S312). If the communication is not connected, the mode conversion unit 210 transmits a message to the communication terminal, asking if the user wants to convert a mode into remote-control mode capable of remotely controlling home appliances. At this time, the message can be transmitted to the user's mobile phone as a voice or image.

When a remote user receives the message through the communication unit 205 and requests conversion to the remote-control mode, the mode conversion unit 210 converts a mode into the remote-control mode. Thereafter, the verifying unit 220 verifies whether the user who requested conversion has a proper authority to access to the devices remotely (S331, S341, and S351).

If the verifying unit 220 determines that the user does not have a proper authority, it terminates the connection. The verifying unit 220 can conduct verification through authentication of the user's individual information or biometrics, such as a finger print, voice, face, or iris, digital signature authentication, Hybrid authentication, or a combination thereof. For example, for a user's individual information, the user inputs his or her ID, password, e-mail address, or identification number. The verifying unit 220 uses the input information, and checks if the user has a proper authority to access and control the device remotely.

Then, if the guide unit 230 determines that the user has a proper authority through the verification unit 220, it transmits the information about the control function of the home appliance to the user's communication terminal through the communication unit 205 (S361). At this time, the guide unit 230 can transmit the information about the device to the user's communication terminal through voice, or a dynamic or still image. The information may include a name of the device that can be controlled, and information about the function for controlling the device. Through the information provided by the guide unit 230, the user can select the function for controlling the home appliance through voice, or by clicking the key button corresponding to the function for controlling the device that he or she wants to control. For example, the on and off settings of an air conditioner may correspond to keys 1 and 2 of a user's mobile phone. When the guide unit 230 transmits this information to the user's mobile phone in a voice or image format, the user can select the function for controlling the air conditioner that he or she wants. For example, the user can select to turn on the air conditioner by clicking key 1.

Then, the generating unit 240 generates a control command corresponding to the information that the user selected among the information provided to the communication terminal, and the conversion unit 250 converts the control command to be compatible with the protocol used by the device (S371).

Then, the transceiver 260 transmits the converted control command to the device selected by a user in his or her communication terminal (S381).

Next, after performing its function according to the control command, the device re-transmits the message regarding the result of performing its function to the transceiver 260, and the transceiver 260 transmits the received message to the user's mobile phone again. If the device does not operate properly according to the corresponding command signal, the relevant error message is transmitted to the user. Otherwise, the message reporting proper completion of the corresponding function is transmitted.

If a user exceeds a predetermined critical time for inputting a predetermined key for remote control, or if the user inputs a key other than the key for converting a mode into a remote-control mode, the mode-converting unit 210 converts the mode into an automatic-telephone-answering mode, and transmits a message to the user, reporting that the connection for communication has failed (S391, S393).

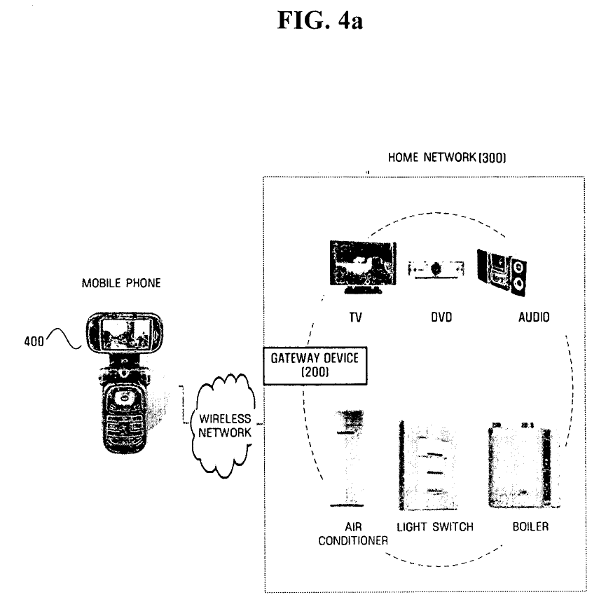

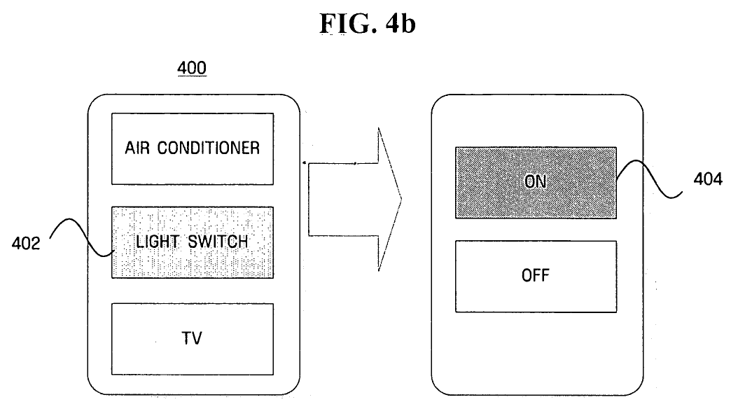

FIGS. 4a and 4b illustrate how home appliances are remotely controlled by a user's communication terminal according to an exemplary embodiment of the present invention.

As illustrated in FIG. 4a, the remote user makes a phone call to the gateway device 200 connected to home appliances on a home network 300. Here, the gateway device 200 is the Internet telephone. If the connection succeeds, the mode conversion unit 210 converts the mode of the Internet telephone into a general communication mode, so that the user can use general telephone communication. If the connection fails, the mode conversion unit 210 informs the user's mobile phone 400 of the conversion, or lack of conversion, to the remote-control mode. When the user pushes a key for converting to the remote-control mode, such as the pound (#) key, the verification unit 220 conducts a user authentication process via the user's ID and password. If the user has a proper authority to access the gateway, the guide unit 230 provides the information about the function for controlling the home appliance, along with a list of the devices, to the user's mobile phone. The guide unit 230 can provide the information about the device in a dynamic or a still image format. If the user uses a wired telephone, such as a public telephone, the information can be provided to the user in a voice format.

As illustrated in FIG. 4b, the user can select the device that he or she wants to control from the list of home appliances displayed on the mobile phone 400. For example, when a user wants to turn on a light switch 402 at home, he or she selects the light switch 402 from the list, and then selects “on” (404) from the control functions. The generation unit 240 generates the control command corresponding to the information selected by the user, by using the information stored in the storage unit 245. At this time, the control command is composed of a combination of the identification information of the device selected by the user, such as a universally unique identifier (UUID) or IP address, and the command language corresponding to the function for controlling the device. When the light switch 402 is networked through a PLC protocol, the conversion unit 250 converts the control command to be compatible with the PLC protocol. Therefore, the device can be controlled, while keeping the conventional network as it was. In addition, the user can perform various control functions, such as remotely turning on the audio, operating the camera, operating the air conditioner, or turning off the light.

As mentioned above, the gateway device for remote control and method for the same may produce one or more of the following effects.

First, the user can control the devices connected to the Internet telephone by way of a home network using the communication terminal.

Second, by using a communication function of the conventional Internet telephone, the device can be controlled, regardless of the protocol used by the device.

Exemplary embodiments of the present invention have been described for illustrative purposes, and those skilled in the art will appreciate that various modifications, additions, and substitutions are possible, without departing from the scope and spirit of the invention as disclosed in the accompanying claims. Therefore, the scope of the present invention should be defined by the appended claims and their legal equivalents.

What is claimed is:

1. A gateway device for remote control, the gateway device comprising:
a verifying unit which verifies whether a user has a proper authority to access a gateway connected to a device;
a guide unit which provides information about the device to a communication terminal of the user if the verifying unit verifies that the user has the proper access authority;
a generating unit which generates a control command corresponding to information selected by the user among the information provided to the communication terminal;
a converting unit which converts the control command which is generated so that the control command is compatible with a protocol used by the device; and
a transceiver which transmits the control command to the device.

2. The gateway device for remote control of claim 1, wherein the gateway device is an Internet telephone.

3. The gateway device for remote control of claim 2, further comprising a mode-converting unit which converts a mode of the Internet telephone based on a condition if the user tries to connect a communication to the Internet telephone using the communication terminal.

4. The gateway device for remote control of claim 3, wherein the mode-converting unit converts the mode into one of a communication mode, an automatic-telephone-answering mode, and a remote-control mode.

5. The gateway device for remote control of claim 4, wherein the mode-converting unit transmits a message asking if the user wants to convert a mode into the remote-control mode to the communication terminal if the communication is not connected.

6. The gateway device for remote control of claim 1, wherein the verifying unit performs verification by using at least one of personal information, a finger print, a voice, an image of an iris, an image, and a digital signature.

7. The gateway device for remote control of claim 1, wherein the guide unit provides information about the device to the communication terminal in a voice format or an image format.

8. The gateway device for remote control of claim 1, wherein the transceiver receives a result of an operation conducted based on the control command of the gateway device, and informs the communication terminal in a voice format or an image format.

9. The gateway device for remote control of claim 1, wherein the protocol is one of a home phone line networking appliance, IEEE 1394, Universal Serial Bus, Ethernet, power line communication, Infrared Data Association, Bluetooth, wireless local area network, home radio frequency, ultra-wide band, digital living network alliance, Java intelligent network infra-structure, and universal plug and play.

10. A method of remote control, the method comprising:
verifying whether a user has a proper authority to access a gateway device connected to a device;
providing a communication terminal of the user with information about the device if it is verified that the user has the proper access authority;
generating a control command corresponding to information selected by the user among the information provided to the communication terminal;
converting the control command which is generated so that the control command is compatible with a protocol used by the device; and
transmitting the control command to the device.

11. The method of remote control of claim 10, wherein the gateway device is an Internet telephone.

12. The method of remote control of claim 11, further comprising converting a mode of the Internet telephone based on a condition if the user tries to connect a communication to the Internet telephone using the communication terminal.

13. The method of remote control of claim 12, wherein the converting the mode comprises converting the mode into a communication mode, an automatic-telephone-answering mode, or a remote-control mode.

14. The method of remote control of claim 13, wherein the converting the mode further comprises transmitting a message asking if the user wants to convert a mode into the remote-control mode to the communication terminal if the communication is not connected.

15. The method of remote control of claim 10, wherein the verifying is performed by using at least one of personal information, a finger print, a voice, an image of an iris, an image, and a digital signature.

16. The method of remote control of claim 10, wherein the guide unit provides voice or image information about the device to the communication terminal during the providing.

17. The method of remote control of claim 10, wherein the transmitting comprises receiving a result of an operation conducted based on the control command of the gateway device, and informing the communication terminal using a voice format or an image format.

18. The method of remote control of claim 10, wherein the protocol is one of a home phone line networking appliance, IEEE 1394, Universal Serial Bus (USB), Ethernet, power line communication, Infrared Data Association, Bluetooth, wireless local area network, home radio frequency, ultra-wide band, digital living network alliance, Java intelligent network infra-structure, and universal plug and play.
